(19) United States
(12) Patent Application Publication
(10) Pub. No.: US 2019/0244369 A1
(43) Pub. Date: Aug. 8, 2019

(54) DISPLAY DEVICE AND METHOD FOR IMAGE PROCESSING

(71) Applicant: SAMSUNG ELECTRONICS CO., LTD., Suwon-si (KR)

(72) Inventors: Kyung-min LIM, Seoul (KR); Se-hoon KIM, Suwon-si (KR); Nupur KALA, Seoul (KR); Young-yoon LEE, Suwon-si (KR); Won-hee CHOE, Seoul (KR); Ji-young KANG, Anyang-si (KR); Kang-Jin YOON, Seoul (KR)

(73) Assignee: SAMSUNG ELECTRONICS CO., LTD., Suwon-si (KR)

(21) Appl. No.: 16/315,482

(22) PCT Filed: Jul. 6, 2017
(86) PCT No.: PCT/KR2017/007208

§ 371 Date: Jan. 4, 2019

(30) Foreign Application Priority Data
Jul. 6, 2016 (KR) 10-2016-0085739

(51) Int. Cl. G06T 7/246; G06T 5/00; H04N 5/232

(52) U.S. Cl. CPC G06T 7/246; H04N 5/23229; H04N 5/23238; G06T 5/003

(57) ABSTRACT

Disclosed are a display device and method for image processing. An image processing method of a display device according to the present invention includes: a step of receiving an input of a plurality of image frames configuring content; a step of analyzing the plurality of image frames to determine a motion of a camera capturing an image of the content; a step of determining a sense of motion sickness on the basis of the camera motion captured; and a step of performing image processing on the plurality of image frames on the basis of the camera motion, when the determined sense of motion sickness is equal to or greater than a predefined value. Accordingly, the display device can reduce the sense of motion sickness for image content having a high possibility of inducing a sense of motion sickness.

### TECHNICAL FIELD

The present disclosure relates to a display device and method for image processing, and more particularly, to a display device for providing an image captured by a plurality of cameras thereof and a method for the same.

### BACKGROUND ART

Recently, in accordance with an immersion display market expanding, there are being widely developed not only stereoscopic images including a 3 dimensional (3D) image but also technologies for virtual environment experience allowing experiencing the same as actual environments.

Especially, in case of a service for the virtual environment experience, it is very important to develop content rich in immersion, active elements and the like in a virtual environment as if a user is experiencing a real. As these contents are developed, users may have an experience as if they undergo the experience in a real environment.

However, when using content in which the above element parts are overused or when experiencing content for a long time, a user may have motion sickness including a feeling of dizziness, nausea or the like depending on a degree of usage.

### DISCLOSURE

### Technical Problem

An object of the present disclosure is to provide a display device capable of minimizing physical and mental changes occurring after experiencing a virtual environment in experiencing the virtual environment using the device.

### Technical Solution

According to an aspect of the present disclosure, an image processing method of a display device includes: receiving a plurality of image frames configuring content; determining a motion of a camera capturing the content by analyzing the plurality of image frames; determining motion sickness on the basis of the camera motion captured; and performing image processing on the plurality of image frames on the basis of the camera motion when the determined motion sickness has a value equal to or greater than a predefined value.

The determining of the motion of the camera may include: detecting each feature point of the plurality of image frames; and determining a size of each motion type of the camera based on an amount of changes in the detected feature points.

Here, the motion type of the camera may be at least one of a motion in an x-axis direction, a motion in a y-axis direction, a motion in a z-axis direction, a roll rotation motion in the x-axis direction, a pitch rotation motion in the y-axis direction, a yaw rotation motion in the z-axis direction and a jitter motion.

The determining of the motion sickness may include: obtaining a motion sickness value based on a size of each motion type of the camera; assigning a weight to the motion sickness value of the each motion type of the camera; and calculating a total motion sickness value by summing the weighted motion sickness values with each other.

The determining of the motion sickness may further include correcting the total motion sickness value based on at least one of user information and environment information.

The determining of the motion of the camera may include: determining a size of each motion type of the camera capturing the content based on information included in metadata when the information on the camera motion is included in the metadata of the plurality of image frames.

The performing of the image processing may include performing the image processing on the plurality of image frames using at least one of a display area adjustment, a frame rate adjustment and a blur correction.

The performing of the image processing may further include performing the image processing on the plurality of image frames using at least one of camera shake correction, brightness and contrast correction, and depth correction.

The determining of the motion of the camera may include determining the camera motion when an operation mode for motion sickness reduction is a manual mode and a user command is input for executing the motion sickness reduction mode.

Here, the content may be a panoramic image generated by synthesizing images captured by a plurality of cameras.

According to another aspect of the present disclosure, a display device includes: a communicator configured to receive a plurality of image frames configuring content; an image processor configured to perform image processing on the plurality of image frames; and a processor configured to determine a motion of a camera capturing the content by analyzing the plurality of image frames, determine motion sickness on the basis of the determined motion, and control the image processor to perform the image processing on the plurality of image frames on the basis of the camera motion, when the determined motion sickness has a value equal to or greater than a predefined value.

The processor may detect each feature point of the plurality of image frames and determine a size of each motion type of the camera based on an amount of changes in the detected feature points.

Here, the motion type of the camera may be at least one of a motion in an x-axis direction, a motion in a y-axis direction, a motion in a z-axis direction, a roll rotation motion in the x-axis direction, a pitch rotation motion in the y-axis direction, a yaw rotation motion in the z-axis direction and a jitter motion.

The processor may obtain a motion sickness value based on a size of each motion type of the camera; assign a weight to the motion sickness value of the each motion type of the camera; and calculate a total motion sickness value by summing the weighted motion sickness values with each other.

The processor may correct the total motion sickness value based on at least one of user information and environment information.

The processor may determine a size of each motion type of the camera capturing the content based on information included in metadata when the information on the camera motion is included in the metadata of the plurality of image frames.

The processor may control the image processor to perform the image processing on the plurality of image frames using at least one of a display area adjustment, a frame rate adjustment and a blur correction.

The processor may control the image processor to further perform the image processing on the plurality of image frames using at least one of camera shake correction, brightness and contrast correction, and depth correction.

The processor may determine the camera motion when an operation mode for motion sickness reduction is a manual mode and a user command is input for executing the motion sickness reduction mode.

Here, the content may be a panoramic image generated by synthesizing images captured by a plurality of cameras.

### Advantageous Effects

As set forth above, according to the present disclosure, the display device may reduce the motion sickness for image content having a high possibility of inducing motion sickness.

### DESCRIPTION OF DRAWINGS

FIG. 1 is a schematic block diagram of a display device according to an embodiment of the present disclosure.

FIG. 2 is a detailed block diagram of a processor according to an embodiment of the present disclosure.

FIG. 3 is an exemplary diagram for determining an area for image frame analysis in a display device according to an embodiment of the present disclosure.

FIG. 4 is an exemplary diagram for determining a motion type of a camera in a display device according to an embodiment of the present disclosure.

FIG. 5 is an exemplary diagram for determining a degree of motion sickness based on the motion type of the camera in a display device according to an embodiment of the present disclosure.

FIG. 6 is a first exemplary diagram for performing image processing for motion sickness reduction in a display device according to an embodiment of the present disclosure.

FIG. 7 is a second exemplary diagram for performing image processing for motion sickness reduction in a display device according to another embodiment of the present disclosure.

FIG. 8 is a third exemplary diagram for performing image processing for motion sickness reduction in a display device according to another embodiment of the present disclosure.

FIG. 9 is a fourth exemplary diagram for performing image processing for motion sickness reduction in a display device according to an embodiment of the present disclosure.

FIG. 10 is a detailed block diagram of a display device according to an embodiment of the present disclosure

FIG. 11 is a flowchart of an image processing method of a display device according to an embodiment of the present disclosure.

FIG. 12 is a flowchart for determining a motion of a camera capturing content in a display device according to an exemplary embodiment of the present disclosure.

FIG. 13 is a flowchart for determining a degree of motion sickness caused by content in a display device according to an embodiment of the present disclosure.

FIG. 14 is a flowchart of a method for performing image processing for motion sickness reduction in a display device according to an embodiment of the present disclosure.

### BEST MODE

Before describing the present disclosure in detail, a method of describing the present specification and drawings will be described. First, general terms are used in the specification and claims in consideration of functions thereof in various embodiments in the present disclosure. However, such terms may be differently used depending on intentions of a person skilled in the art, a legal or technical interpretation, or an emergence of a new technology. In addition, some terms are arbitrarily selected by the applicant. These terms may be construed in the meaning defined herein and, unless otherwise specified, may be construed on the basis of the entire contents of the specification and common technical knowledge in the art.

In addition, throughout the accompanying drawings of the present specification, the same reference numerals denote parts or components performing substantially the same functions. For convenience of explanation and understanding, different embodiments will be described using the same reference numerals or signs. In other words, even though all the elements having the same reference numerals are illustrated in a plurality of drawings, the plural drawings may not refer to the same embodiment.

In the specification and the claims, a term including an ordinal number such as “first”, “second” or the like may be used only to distinguish the same or similar components from each other and therefore, each of the components is not limited by the ordinal number. For example, any component associated with such an ordinal number is not limited in the orders of use, placement and etc. When necessary, each ordinal number may be used interchangeably.

In the present specification, singular forms include plural forms unless the context clearly indicates otherwise. It will be further understood that terms “include” or “formed of” used in the present specification specify the presence of features, numerals, steps, operations, components, parts, or combinations thereof mentioned in the present specification, but do not preclude the presence or addition of one or more other features, numerals, steps, operations, components, parts, or combinations thereof.

In the exemplary embodiment of the present disclosure, a term such as a “module”, a “unit” or a “part” is used to indicate a component performing at least one function or operation, and enabled to be implemented with hardware, software, or a combination of hardware and software. In addition, a plurality of “modules”, “units”, “parts” or the like may be integrated into at least one module or chip and implemented with at least one processor (not shown) except for a case in which a “module”, a “unit” or a “part” has to be individually implemented with a specific hardware.

In addition, in the present specification, it is to be understood that when one component is referred to as being ‘connected to’ another component, it may be connected directly to another component or be indirectly connected to another component with a third component interposed therebetween. Unless explicitly described otherwise, “comprising” any components will be understood to imply the inclusion of other components but not the exclusion of any other components.

Hereinafter, various exemplary embodiments of the present disclosure will be described in detail with reference to the accompanying drawings.

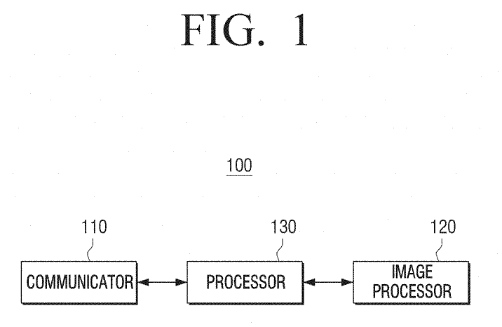

FIG. 1 is a schematic block diagram of a display device according to an embodiment of the present disclosure.

As illustrated in FIG. 1, a display device 100 may be an electronic device for displaying images, in particular, a device for providing panoramic image content in a virtual reality (VR) environment.

The display device 100 includes a communicator 110, an image processor 120 and a processor 130.

The communicator 110 receives a plurality of image frames configuring the content, and the image processor 120 performs image processing on the plurality of image frames input through the communicator 110. Here, each of the plurality of image frames is an image frame in which image frames captured by a plurality of cameras are combined with each other. The content including the plurality of image frames may be a panorama image capable of providing a 360-degree panoramic view image.

The processor 130 controls an overall operation of each of the components configuring the display device 100. In particular, when a plurality of image frames are input through the communicator 110, the processor 130 determines a motion of a camera capturing the content by analyzing the plurality of image frames and determines motion sickness based on the determined motion. Thereafter, the processor 130 controls the image processor 120 to perform the image processing on the plurality of image frames on the basis of the motion of the camera capturing the content, when the determined motion sickness has a value equal to or greater than a predefined value.

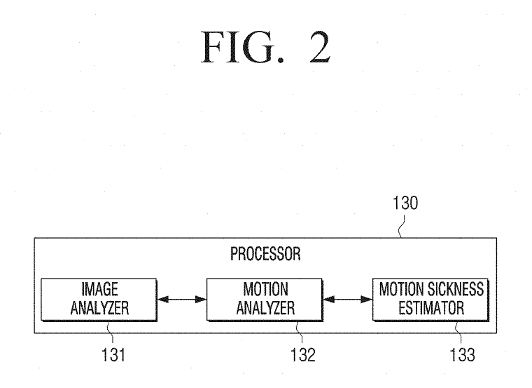

Such a processor 130 may be implemented as illustrated in FIG. 2.

FIG. 2 is a detailed block diagram of a processor according to an embodiment of the present disclosure.

As illustrated in FIG. 2, the processor 130 includes an image analyzer 131, a motion analyzer 132, and a motion sickness estimator 133.

When a plurality of image frames are input through the communicator 110, the image analyzer 131 detects each feature point of the plurality of input image frames. The motion analyzer 132 then determines a size of each motion type of the camera capturing the content based on an amount of changes in feature points of the plurality of image frames detected by the image analyzer 131.

Here, the motion type may be at least one of a motion in an x-axis direction, a motion in a y-axis direction, a motion in a z-axis direction, a roll rotation motion in the x-axis direction, a pitch rotation motion in the y-axis direction and a yaw rotation motion in the z-axis direction and a jitter motion.

To be specific, when a first image frame and a second image frame continued from the first image frame are input, the image analyzer 131 detects the feature point from the first image frame. According to an exemplary embodiment, the image analyzer 131 may detect the feature point on a boundary region of an object of the first image frame. When the feature point of the first image frame is detected, the image analyzer 131 detects the feature point of the second image frame based on a pixel corresponding to the feature point of the first image frame. The motion analyzer 132 thereafter may analyze the amount of changes in the feature point of the first image frame and the feature point of the second image frame, determine the motion type of the camera capturing the first and second image frames and then, determine a size of each determined motion type.

Meanwhile, the camera capturing the content may include a motion sensor such as a gyroscope sensor, an acceleration sensor and the like. In this case, when capturing the content, the camera may generate metadata using a sensed value sensed by a motion sensor and create the content including the metadata.

When a plurality of image frames configuring the content are input, the motion analyzer 132 may determine motion elements of the camera capturing the content and a size of each of the motion elements referring to the metadata included in the content.

However, the present disclosure is not limited thereto, and the motion analyzer 132 may determine a motion type of the camera capturing the content and a size of each motion type of the camera by analyzing the amount of changes in the feature points detected from each of the plurality of image frames configuring the above-mentioned content and the metadata included in the content.

Meanwhile, when information on the camera motion is included in the metadata of a plurality of image frames, the motion analyzer 132 may determine a size of each motion type of the camera capturing the content based on the information included in the metadata.

Known is a technology for detecting a feature point from a plurality of image frames and determining a size of each motion type based on an amount of changes in the detected feature points, and a detailed description thereof will thus be omitted in the present disclosure.

When the size of each motion type of the camera is determined in an embodiment, the motion sickness estimator 133 obtains a motion sickness value of each motion type of the camera, and assigns a predetermined weight to the obtained motion sickness value of the each motion type of the camera. However, the present disclosure is not limited thereto, and the motion sickness estimator 133 may set a weight of the motion type having a high possibility of inducing motion sickness and that having a low possibility of inducing motion sickness different from each other, among motion types of the camera.

Thereafter, when the weighted motion sickness value is determined for each motion type of the camera, the motion sickness estimator 133 calculates a total motion sickness value by summing each weighted motion sickness value of the motion types of the camera with each other. The total motion sickness value for each motion type of the camera may be determined based on [Equation 1] as below.

S_{sicknessTotal}=α*S₁+β*S₂+γ*S₃ [Equation 1]

Here, S_{SicknessTotal} is a total motion sickness value and S₁, S₂, and S₃ may be motion elements of the camera.

In such a state in which the total motion sickness value is determined, the motion sickness estimator 133 may adjust the determined total motion sickness value based on at least one of the predetermined user information and the environment information.

Here, the user information may be a user's age, gender, body information and the like, and the environment information may be ambient temperature, humidity, the user's operation state, and the like.

For example, when the user is a female in her forties, the processor 130 may adjust the total motion sickness value to be higher than that of a male user in his forties.

When the total motion sickness value is determined, the motion sickness estimator 133 controls the image processor 120 to perform image processing on a plurality of image frames by using at least one of display area adjustment, frame rate adjustment and blur correction.

According to an embodiment, the motion sickness estimator 133 compares the determined total motion sickness value with a predetermined threshold value and controls the processor 120 to perform image processing for motion sickness reduction when the total motion sickness value exceeds the predetermined threshold value. According to such a control command, the image processor 120 may perform the image processing on the plurality of image frames using image processing methods related to the display area adjustment, the frame rate adjustment, and the blur correction.

According to another embodiment, depending on a level of the total motion sickness value, the motion sickness estimator 133 may control the image processor 120 to perform the image processing on the plurality of image frames using an image processing method set corresponding to a level of an initial motion sickness value among the image processing methods related to the display area adjustment, the frame rate adjustment, and the blur correction.

For example, the motion sickness estimator 133 may control the image processor 120 to perform the image processing on the plurality of image frames by: using an image processing method related to the display area adjustment when the total motion sickness value exceeds a predetermined first threshold value; and using image processing methods related to the display area adjustment and the frame rate adjustment when the total motion sickness value exceeding the predefined first threshold is less than or equal to a predefined second threshold value. The motion sickness estimator 133 may control the image processor 120 to perform the image processing on the plurality of image frames by using the image processing methods related to the display area adjustment, the frame rate adjustment and the blur correction when the total motion sickness value exceeds the predefined second threshold value.

In accordance with such a control command, the image processor 120 may perform the image processing on the plurality of image frames by using the image processing method set corresponding to the level of the total motion sickness value among the image processing methods related to the display area adjustment, the frame rate adjustment and the blur correction.

Meanwhile, the processor 130 may control the image processor 120 to perform the image processing on the plurality of image frames by using: at least one of image process methods including camera shake correction, brightness and contrast correction, and depth correction as well as the above-mentioned the image processing methods related to the display area adjustment, the frame rate adjustment and the blur correction.

According to an embodiment, when the total motion sickness value is equal to or less than a predefined threshold value, the processor 130 may determine that there is a low possibility of inducing motion sickness and then, control the image processor 120 to perform the image processing on the plurality of image frames by using the at least one of the image process methods including the camera shake correction, the brightness and contrast correction, and the depth correction.

In accordance with such a control command, the image processor 120 may perform the image processing on the plurality of image frames by using the at least one of the image processing methods including the camera shake correction, the brightness and contrast correction, and the depth correction.

According to a further aspect of the present disclosure, the processor 130 may control the image processor 120 to perform the image processing on the plurality of image frames by implementing a series of the above-mentioned operations, when an operation mode for motion sickness reduction is a manual mode and a user command is input for executing the sickness reduction mode.

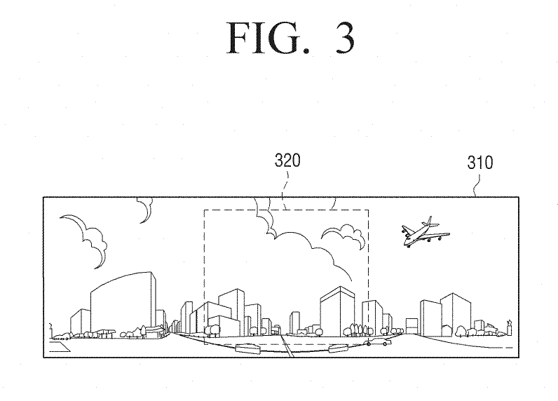

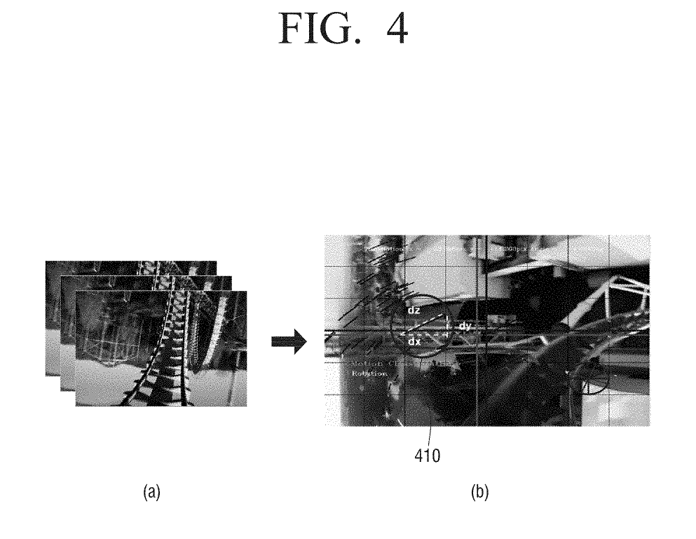

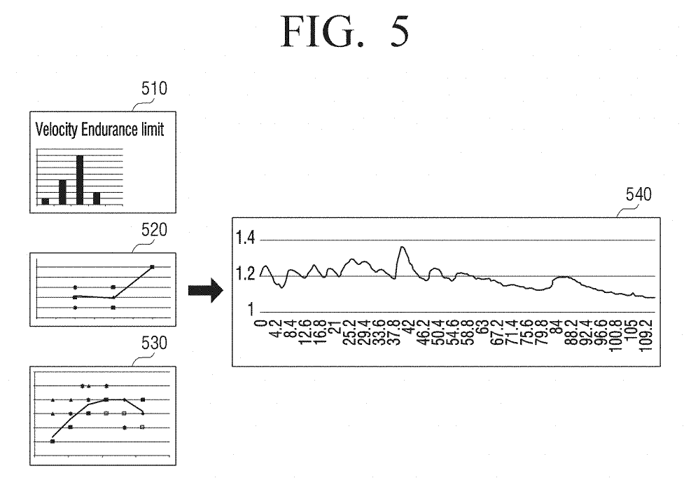

FIG. 3 is an exemplary diagram for determining an area for image frame analysis in a display device according to an embodiment of the present disclosure; FIG. 4 is an exemplary diagram for determining a motion type of a camera a display device according to an embodiment of the present disclosure; and FIG. 5 is an exemplary diagram for determining a degree of motion sickness based on the motion type of the camera a display device according to an embodiment of the present disclosure.

As illustrated in FIG. 3, when an image frame for specific content is input, the processor 130 selects an area for determining a motion of the camera capturing the content from the input image frame.

As illustrated in FIG. 3, when the image frame configuring the content is input, the display device 100 selects an area for image analysis from an image 310 corresponding to the input image frame.

Here, an image of the image frame 310 configuring the content may be a panorama image generated by connecting the image frames captured by the plurality of cameras with each other. When such an image frame is input, the display device 100 determines a partial image frame 320 for image analysis from the image frame 310, which is input to the display device 100 through the processor 130.

According to an embodiment, the processor 130 may determine the partial image frame 320 for image analysis based on a user's gaze direction on the input image frame 310. To be specific, the processor 130 may sense a position in a direction in which the user's gaze is directed and then track a position in a direction in which the user's gaze is moved from the sensed position. According to an embodiment, the processor 130 may sense the user's gaze by tracking the position in the direction in which the user's gaze is moved from the sensed position using a sensor capable of pupil-tracking, which will be described below. Known is a technology for sensing such a user's gaze, and a detailed description thereof will thus be omitted in the present disclosure.

Meanwhile, when the user's gaze is sensed, the processor 130 may determine the partial image frame 320 for image analysis from the image frame 310 based on a direction in which the sensed gaze is directed. The processor 130 may thus determine the partial image frame for image analysis from each of a plurality of continuous image frames configuring the content according to the above-mentioned embodiment.

To be specific, as illustrated in FIG. 4A, the processor 130 may determine the partial image frame for image analysis from each of the plurality of image frames configuring the content. As such, when the partial image for image analysis is determined, the processor 130 detects the feature point from each of the partial image frames. Thereafter, as illustrated in FIG. 4B, the processor 130 determines the motion type of the camera capturing each of the partial image frames based on the amount of changes in a feature point detected from each partial image frame, and then determines the size of each determined motion type of the camera. That is, the processor 130 may analyze the amount of changes in a feature point 410 detected from a plurality of partial image frames, determine the motion type of the camera capturing the plurality of partial image frames and then, determine the size of the determined motion type.

Here, the motion type may be at least one of a motion in an x-axis direction, a motion in a y-axis direction, a motion in a z-axis direction, a roll rotation motion in the x-axis direction, a pitch rotation motion in the y-axis direction, a yaw rotation motion in the z-axis direction and a jitter motion.

Thereafter, the processor 130 may determine a degree of motion sickness based on the size of each motion type of the camera determined based on the amount of changes in the detected feature points from the plurality of partial image frames. To be specific, the processor 130 may obtain each motion sickness value of the motion types of the camera based on the determined sizes of the motion types of the camera referring to a predefined motion sickness estimation model for each motion sickness type.

As illustrated in FIG. 5, there may be predefined a first motion sickness estimation model 510 for the roll rotation motion type in the x-axis direction, a second motion sickness estimation model 520 for the pitch rotation motion type in the y-axis direction, and a third motion sickness detect prediction model 530 for the yaw rotation motion type in the z-axis direction.

There may be determined sizes of the roll rotation motion type in the x-axis direction of the camera, the pitch rotation motion type in the y-axis direction of the camera, and the yaw rotation motion type in the z-axis direction of the camera based on the amount of changes in the feature points detected from the plurality of partial image frames.

In this case, referring to the first to third motion sickness estimation models 510 to 530, the processor 130 obtains determined motion sickness values respectively corresponding to the sizes of the roll rotation motion type in the x-axis direction of the camera, the pitch rotation motion type in the y-axis direction of the camera, and the yaw rotation motion type in the z-axis direction of the camera. Thereafter, the processor 130 calculates a total motion sickness value 540 of each of the image frames using the motion sickness value of each motion type obtained referring to the first to third motion sickness estimation models 510 to 530.

As described above, the processor 130 multiplies an obtained motion sickness value of each motion type of the camera by a predefined weight for the each motion type of the camera; summing all the motion sickness values of the motion types multiplied by the weights with each other; and then, calculates the total motion sickness value 540 corresponding to each of a plurality of image frames configuring the content.

Here, the processor 130 may adjust the determined total motion sickness value 540 using additional information including at least one of the predefined user information and the environment information.

Thereafter, the processor 130 may determine whether to perform image processing on a plurality of image frames referring to the total motion sickness value 540 corresponding to each of the plurality of image frames configuring the content.

According to an embodiment, the processor 130 compares the total motion sickness value 540 corresponding to each of the plurality of image frames with the predefined threshold value, and controls the image processor 120 to perform the image processing for motion sickness reduction on an image frame with the total motion sickness value higher or lower than the predefined threshold value.

According to another embodiment, the processor 130 may analyze the amount of changes in the total motion sickness value 540 corresponding to each of a plurality of image frames, and controls the image processor 120 to perform the image processing for motion sickness reduction on an image frame in a section in which the amount of changes indicates a value higher or lower than the predefined threshold value.

In accordance with such a control command, the image processor 120 may perform image processing for motion sickness reduction on at least one image frame among a plurality of image frames.

Hereinafter, there will be described an operation of performing image processing for motion sickness reduction in a display device in detail.

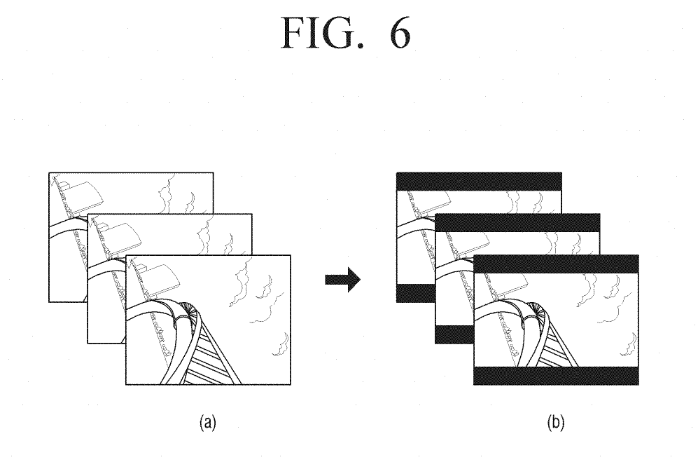

FIG. 6 is a first exemplary diagram for performing image processing for motion sickness reduction in a display device according to an embodiment of the present disclosure.

The display device 100 may display an image in which a display area is adjusted for at least one image frame determined to have a high possibility of inducing motion sickness among a plurality of image frames configuring the content.

The processor 130 may extract an image frame which may cause motion sickness among the plurality of image frames as illustrated in FIG. 6A based on the total motion sickness value corresponding to each of the plurality of image frames configuring the content as illustrated in FIG. 5. When the image frame which may cause motion sickness is extracted, the image processor 120 adjusts the display area of the image of the image frame which may cause motion sickness, as illustrated in FIG. 6B.

To be specific, the image processor 120 may reduce motion sickness of the corresponding image frame by performing image processing for adjusting a field of view (FOV) of the image of the image frame which may cause motion sickness. Here, the image processor 120 may adjust the FOV such that the image of the image frame which may cause the motion sickness is adjusted at the same ratio for the up and down or the left and right of an entire screen. However, the present disclosure is not limited thereto, and the image processor 120 may adjust the FOV such that the image of the corresponding image frame is adjusted at a different ratio on the entire screen.

In addition, the image processor 120 may adjust the FOV such that a vertical or horizontal direction of the screen is adjusted, or both the vertical and horizontal directions are adjusted. Such a FOV adjustment method may be a method of processing the display area in black, a method of processing black gradation so that the area gets darker outward, and a method of performing blurring.

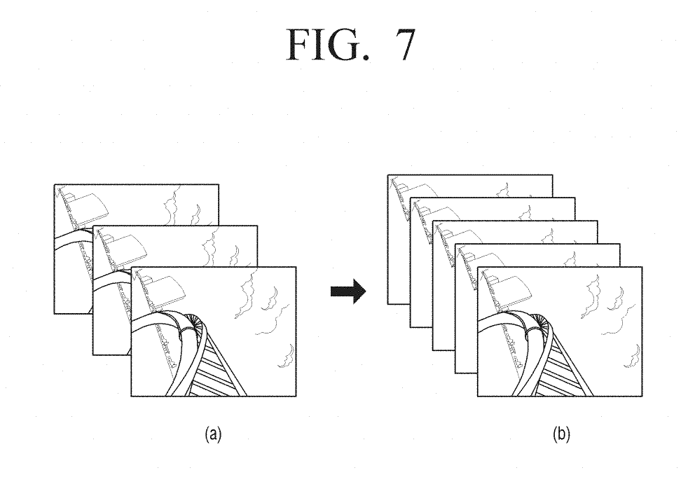

FIG. 7 is a second exemplary diagram for performing image processing for motion sickness reduction in a display device according to another embodiment of the present disclosure.

The display device 100 may adjust the frame rate to display at least one image frame determined to have a high possibility of inducing motion sickness among a plurality of image frames configuring the content.

As illustrated in FIG. 5, the processor 130 may determine a section in which a motion sickness may occur among a plurality of image frames based on the total motion sickness value corresponding to each of the plurality of image frames configuring the content. When a section in which motion sickness may occur is determined, the image processor 120 adjusts the frame rate by increasing the number of image frames included in the corresponding section.

To be specific, as illustrated in FIG. 7A, first to third continuous image frames may be included in a section in which motion sickness may occur. In this case, as illustrated in FIG. 7B, the image processor 120 generates and inserts a new image frame based on the first to third image frames included in the section in which motion sickness may occur. According to an embodiment, the image processor 120 may generate an image frame having an intermediate value based on pixel values of the first and second image frames in the section in which motion sickness may occur, and an image frame having an intermediate value based on pixel values of the second and third image frames.

Thereafter, the image processor 120 inserts newly generated image frames between the first to third image frames, respectively. As described above, the image processor 120 according to the present disclosure may increase the frame rate in the corresponding section by increasing the number of image frames in the section in which motion sickness may occur.

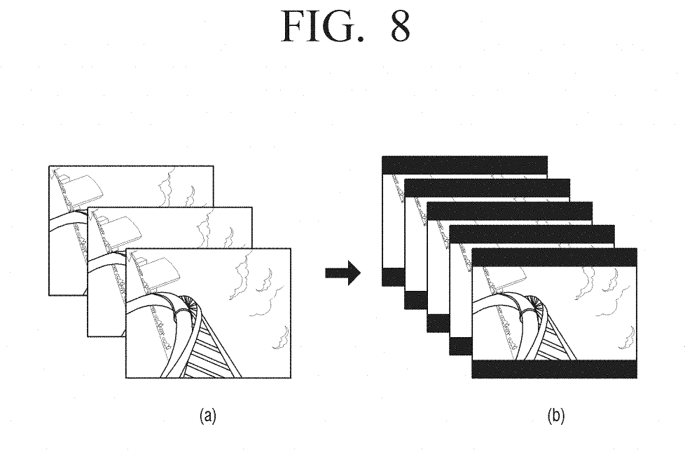

FIG. 8 is a third exemplary diagram for performing image processing for motion sickness reduction in a display device according to another embodiment of the present disclosure.

The display device 100 may adjust the display area and the frame rate to display at least one image frame determined to have a high possibility of inducing motion sickness among a plurality of image frames configuring the content.

As illustrated in FIG. 5, the processor 130 may determine a section in which motion sickness may occur among a plurality of image frames based on the total motion sickness value corresponding to each of the plurality of image frames configuring the content. When a section in which motion sickness may occur is determined, the image processor 120 adjusts the frame rate by increasing the number of image frames in the corresponding section. Thereafter, the image processor 120 performs image processing for adjusting the display area of the image frame of which frame rate is adjusted.

To be specific, as illustrated in FIG. 8A, the first to third continuous image frames may be included in the section in which motion sickness may occur. In this case, as illustrated in FIG. 7B, the image processor 120 generates and inserts a new image frame based on the first to third image frames included in the section in which motion sickness may occur. According to an embodiment, the image processor 120 may generate an image frame having an intermediate value based on the pixel values of the first and second image frames included in the section in which motion sickness may occur, and an image frame having an intermediate value based on the pixel values of the second and third image frames.

Thereafter, the image processor 120 inserts newly generated image frames between the first to third image frames, respectively. When the new image frames are respectively inserted between the first to third image frames, the image processor 120 performs image processing for adjusting the FOV on the first to third image frames and each image of the image frames inserted between the first to third image frames. Accordingly, motion sickness may be reduced in the images of a plurality of image frame in the section in which motion sickness may occur. Here, the image processor 120 may adjust the FOV such that the image of the image frame which may cause the motion sickness is adjusted at the same ratio for the up and down or the left and right of the entire screen. However, the present disclosure is not limited thereto, and the image processor 120 may adjust the FOV such that the image of the corresponding image frame is adjusted at a different ratio on the entire screen.

In addition, the image processor 120 may adjust the FOV such that the vertical or horizontal direction of the screen is adjusted, or both the vertical and horizontal directions are adjusted. Such a FOV adjustment method may be a method of processing the display area in black, a method of processing black gradation so that the area gets darker outward, and a method of performing blurring.

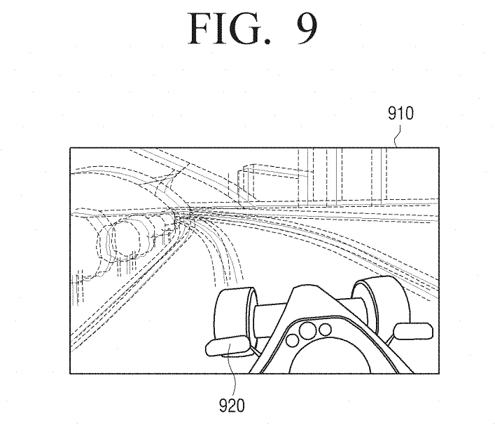

FIG. 9 is a fourth exemplary diagram for performing image processing for motion sickness reduction in a display device according to an embodiment of the present disclosure.

The display device 100 may display at least one image determined to have a high possibility of inducing motion sickness among a plurality of image frames constituting the content with a blur-corrected image in a periphery thereof.

As illustrated in FIG. 5, the processor 130 may extract an image frame that may cause motion sickness among a plurality of image frames, based on the total motion sickness value corresponding to each of the plurality of image frames configuring the content. As illustrated in FIG. 9, when the image frame which may cause motion sickness is extracted, the image processor 120 may generate blur effect in a periphery of the image by blurring the image of the remaining region excluding a first object image 920 in an image 910 of the image frame which may cause motion sickness.

In general, an area blurred in the image frame may be the image of the remaining area excluding the image of the area included in a circle or an ellipse size based on the center of the image. That is, the image of the region included in the circle or the ellipse size with reference to a center of the image may be output as an original image, and the image of the remaining region may be output as the blurred image.

As described above, according to the present disclosure, the image of the remaining region excluding the area in which the specific object image is displayed is blurred in the section in which motion sickness may occur, thereby reducing motion sickness which may occur from the image in the corresponding section.

As described above, the communicator 110 receiving a plurality of image frames configuring the content from the outside may include a local communication module 111, a wireless communication module 112, and a connector 113.

The local communication module 111 is configured to wirelessly perform local communications between the display device 100 and peripheral electronic devices (not shown). The local communication module 111 may include at least one of a Bluetooth module, an Infrared Data Association (IrDA) module, a Near Field Communication (NFC) module, a WiFi module, and a Zigbee module.

The wireless communication module 112 is connected to an external network and performs communication according to a wireless communication protocol such as Institute of Electrical and Electronics Engineers (IEEE) protocol. In addition, the wireless communication module may further include a mobile communication module for performing communications by accessing a mobile communication network according to various mobile communication standards such as 3rd generation (3G), 3rd Generation Partnership Project (3GPP), and Long Term Evolution (LTE).

As described above, the communicator 110 may be implemented by the above-mentioned various local communication methods, and may employ other communication technologies not mentioned in this disclosure as needed.

Meanwhile, the connector 113 is configured to provide interfaces with various source devices such as universal serial bus (USB) 2.0, USB 3.0, high-definition multimedia interface (HDMI) and institute of electrical and electronics engineers (IEEE) 1394. The connector 113 may receive content transmitted from an external server (not shown) via a wired cable connected to the connector 113 according to a control command of the processor 130, or may receive or transmit content from a physically connected electronic device (not shown), an external recording medium or the like. In addition, the connector 113 may receive power from a power source via a wired cable physically connected to the connector 113.

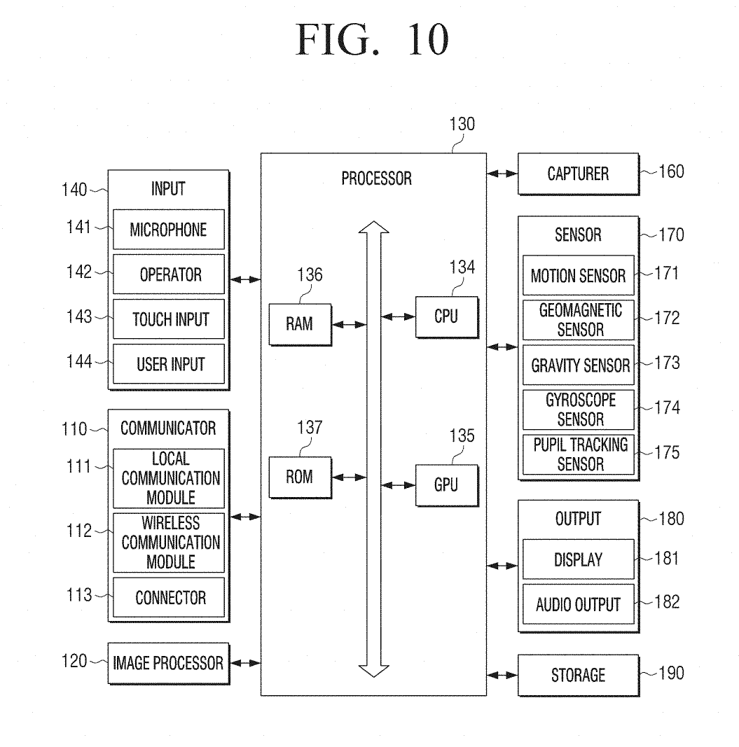

Meanwhile, when implemented as a smart phone, a multimedia device, or the like, the display device 100 may further include a configuration as illustrated in FIG. 10 in addition to the configuration described above.

FIG. 10 is a detailed block diagram of a display device according to an embodiment of the present disclosure.

As illustrated in FIG. 10, the display device 100 may include an input 140, a capturer 160, a sensor 170, an output 180, and a storage 190 as well as the above-mentioned communicator 110, image processor 120 and processor 130.

The input 140 may include a microphone 141, an operator 142, a touch input 143 and a user input 144 as input means for receiving various user commands and transmitting the commands to the processor 130.

The microphone 141 may receive voice commands of the user and the operator 142 may be implemented as a keypad having various function keys, numeric keys, special keys, and character keys. The touch input 143 may be implemented as a touch pad having a mutual layer structure with a display 181 to be described below. In this case, the touch input 143 may receive a command for selecting various application-related icons displayed through the display 181.

The user input 144 may receive an Infrared (IR) signal or a radio-frequency (RF) signal for controlling the operation of the display device 100 from at least one peripheral device (not shown) such as a remote control device.

The capturing unit 160 captures a still image or a video image according to a user command, and may be implemented as a plurality of cameras such as a front camera and a rear camera.

The sensor 170 may include a motion sensor 171 for sensing a motion of the display device 100, a magnetic sensor 172, a gravity sensor 173, a gyroscope sensor 174 and a pupil tracking sensor 175.

The motion sensor 171 may be an accelerometer sensor for measuring acceleration or impact of a moving display device 100.

The magnetic sensor 172 is an electronic compass for detecting an azimuth using a geomagnetic field. The magnetic sensor 172 is used for location tracking, 3D video game and etc., and used for a smart phone, a radio, GPS, a PDA, a navigation device and the like.

The gravity sensor 173 is a sensor for sensing a direction in which gravity acts, and used to detect the direction by rotating automatically in accordance with the moving direction of the display device 100.

The gyroscope sensor 174 is a sensor that recognizes the six-axis direction by rotating the conventional motion sensor 171 to recognize a more detailed and precise operation.

The pupil tracking sensor 175 is located near a user's eyeballs and senses changes in the user's gaze while capturing the user's pupils.

In addition, the sensor 170 of the present disclosure may further include a proximity sensor (not shown) for determining whether an object is close to another object before contacting the another object in addition to the above-described configuration, an optical sensor (not shown) for sensing light and converting the detected light into an electric signal and the like.

The output 180 outputs content image-processed by the image processor 120. The output 180 may output video and audio data of the content through at least one of the display 181 and an audio output 182. That is, the display 181 displays image data which is image-processed by the image processor 120, and the audio output 182 outputs audio data which is audio-signal processed to have a form of audible sound.

Meanwhile, the display 181 for displaying the image data may be implemented as a liquid crystal display (LCD), an organic light emitting diode (OLED), a plasma display panel (PDP) or the like. In particular, the display 181 may be implemented as a touch screen having a mutual layer structure with the touch input 143.

The storage 190 may store image contents such as respective images captured by a plurality of cameras and panorama images generated from the respective images, or store image and audio data of contents received from an external server (not shown). In addition, the storage 190 may further store an operation program for controlling an operation of the display device 100. Here, the operating program may be read and compiled in the storage 190 to operate each component of the display device 100 when the display device 100 is turned on.

Meanwhile, the processor 130 may further include a central processing unit (CPU) 134, a graphics processing unit (GPU) 135, a random access memory (RAM) 136, and a read only memory (ROM) 137. The CPU 134, the GPU 135, the RAM 136 and the ROM 137 may be connected to each other via a bus (not shown).

The CPU 134 accesses the storage 190 and performs booting using an operating system (OS) stored in the storage 190. The CPU 134 also performs various operations using various programs, contents, data and the like stored in the storage 190.

The GPU 135 generates a display screen including various objects such as icons, images, text, and the like. To be specific, the GPU 135 computes attribute values, such as a coordinate value, a shape, a size, and a color, to be displayed by each object according to a layout of the screen based on an received control command; and generates a display screen with various layouts including the objects based on the computed attribute values.

The ROM 137 stores a command set and the like for booting the system. When a turn-on command is input and power is supplied, the CPU 134 copies the OS stored in the storage 190 to the RAM 136 according to a command stored in the ROM 137, and executes the OS to boot the system. When the booting is completed, the CPU 134 copies various programs stored in the storage 190 to the RAM 136, and executes the copied program in the RAM 136 to perform various operations.

The processor 130 may be implemented as a system-on-a-chip (SOC) or a system-on-chip (SoC) in combination with each of the above-described configurations.

The operation of the processor 130 may be performed by a program stored in the storage 190. Here, the storage 190 may be implemented as at least one of the ROM 137, the RAM 136, or a memory card (e.g., SD card or memory stick) attachable/detachable to the display device 100, a nonvolatile memory, a volatile memory, a hard disk drive (HDD) or a solid state drive (SSD).

As seen above, each configuration of the display device 100 according to the present disclosure has been described in detail.

Hereinafter, a method of controlling the operation of the display device 100 according to the present disclosure will be described in detail.

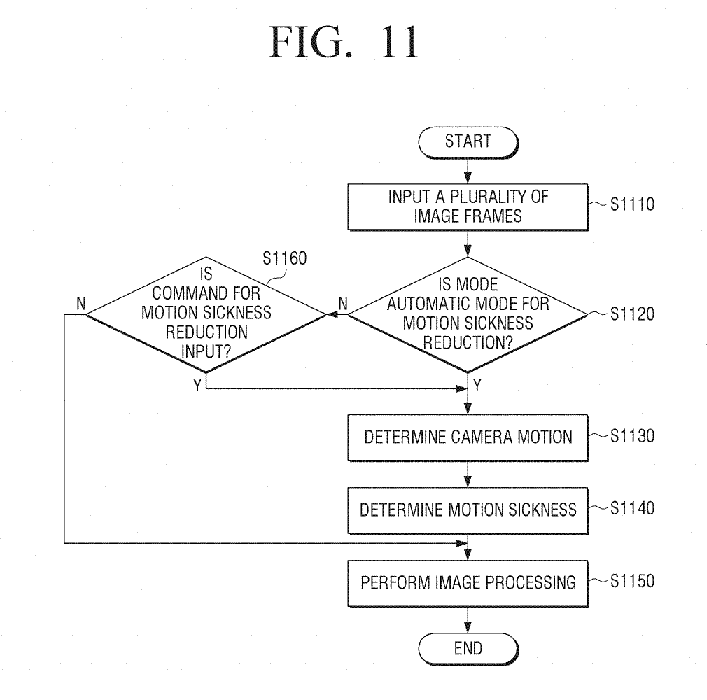

FIG. 11 is a flowchart of an image processing method of a display device according to an embodiment of the present disclosure.

As illustrated in FIG. 11, the display device 100 receives a plurality of image frames configuring the content (S1110). Here, each of the plurality of image frames is an image frame in which image frames captured by a plurality of cameras are combined with each other. The content including the plurality of image frames may be a panorama image capable of providing a 360-degree panoramic view image.

When the plurality of image frames are input, the display device 100 determines whether a mode is a mode for automatically performing motion sickness reduction (S1120).

When it is determined that the operation mode for motion sickness reduction is the automatic mode, the display device 100 analyzes the plurality of image frames and determines the motion of the camera capturing the content (S1130). Thereafter, the display device 100 determines motion sickness based on the motion of the camera capturing the corresponding content (S1140). Thereafter, when the determined motion sickness has a value equal to or greater than the predefined value, the display device 100 performs image processing for motion sickness reduction on a plurality of image frames based on the motion of the camera capturing the content (S1150).

Meanwhile, when the operation mode for motion sickness reduction is a manual mode in above S1120, the display device 100 determines whether a user command is input for motion sickness reduction operation (S1160). When the user command is input for the motion sickness reduction operation resulting from the determination, the display device 100 performs the operations of the S1130 to S1150 described above.

Meanwhile, when no user command is input for the motion sickness reduction operation (S1160), the display device 100 performs a general image processing in above S1150.

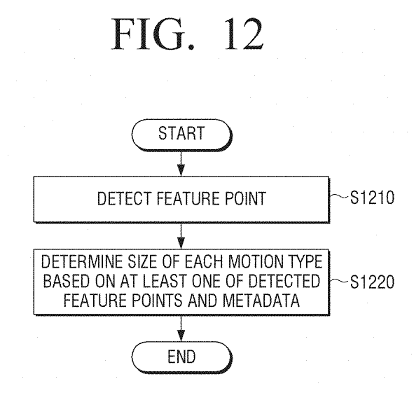

FIG. 12 is a flowchart for determining a motion of a camera capturing content in a display device according to an exemplary embodiment of the present disclosure.

As illustrated in FIG. 12, when a plurality of image frames configuring the content are input, the display device 100 detects feature points of each of a plurality of image frames (S1210). Thereafter, the display device 100 determines the motion type of the camera capturing the content based on at least one of the feature points detected from each of the plurality of image frames and the metadata of the plurality of image frames, and then determines the size of the determined motion type (S1220).

Here, the motion type of the camera may be at least one of a motion in an x-axis direction, a motion in a y-axis direction, a motion in a z-axis direction, a roll rotation motion in the x-axis direction, a pitch rotation motion in the y-axis direction, a yaw rotation motion in the z-axis direction and a jitter motion.

To be specific, the display device 100 may detect feature points of each of the continuous image frames, analyze the amount of changes in the detected feature points, determine the motion type of the camera capturing continuous image frames, and then determine a size of the determined motion type.

Meanwhile, the camera capturing the content may include a motion sensor such as a gyroscope sensor, an acceleration sensor and the like. In this case, the camera may generate metadata using a sensed value sensed by a motion sensor when capturing the content and generate the content including the metadata.

Accordingly, the display device 100 may determine a motion type of the camera capturing the content and a size of each motion type of the camera by analyzing the amount of changes in the feature points detected from each of the plurality of image frames configuring the content and the metadata included in the content.

However, the present disclosure is not limited thereto, and the display device 100 may determine motion elements of the camera capturing the content and a size of each of the moving elements using the amount of changes in the feature points detected from each of the plurality of image frames configuring the content or only using the metadata included in the content.

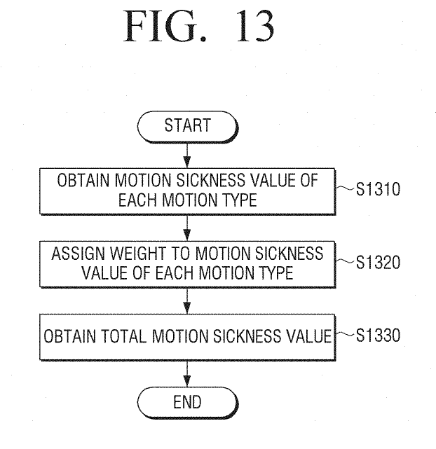

FIG. 13 is a flowchart for determining a degree of motion sickness caused by content in a display device according to an embodiment of the present disclosure.

As illustrated in FIG. 13, when a size of each motion type of the camera capturing the content is determined, the display device 100 obtains a motion sickness value of each motion type based on the size of the each motion type (S1310).

To be specific, the display device 100 may obtain a motion sickness value of each motion type of the camera based on the determined size of each motion type of the camera referring to a predetermined motion sickness estimation model for each motion sickness type.

Thereafter, the display device 100 assigns a predefined weight for each motion type to the obtained motion sickness value of each motion type of the camera (S1320). Here, the display device 100 obtains a total motion sickness value of the plurality of image frames configuring the content by summing all the weighted motion sickness values of the motion types of the camera with each other (S1330). Here, the display device 100 may adjust the determined total motion sickness value using additional information including at least one of the predefined user information and the environment information.

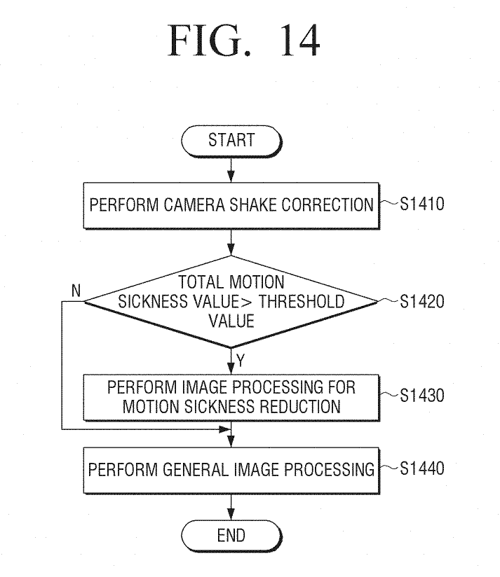

FIG. 14 is a flowchart of a method for performing image processing for reducing motion sickness in a display device according to an embodiment of the present disclosure.

As illustrated in FIG. 14, when a plurality of image frames configuring the content are input, the display device 100 performs camera shake correction on the input image frame (S1410). Thereafter, the display device 100 compares the determined total motion sickness value of the plurality of image frames configuring the content with a predefined threshold value and performs the image processing for motion sickness reduction on the image frame having the total motion sickness value exceeding the predefined threshold value (S1420 and S1430).

According to an embodiment, when the total motion sickness value exceeds the predefined threshold value, the display device 100 may perform the image processing on the plurality of image frames using image processing methods related to the display area adjustment, the frame rate adjustment, and the blur correction.

According to another embodiment, the display device 100 may perform the image processing on the plurality of image frames by using a image processing method set corresponding to a level of an initial motion sickness value among the image processing methods related to the display area adjustment, the frame rate adjustment, and the blur correction. For example, the display device 100 may perform the image processing on the plurality of image frames by: using an image processing method related to the display area adjustment when the total motion sickness value exceeds a predefined first threshold value; and using image processing methods related to the display area adjustment and the frame rate adjustment when the total motion sickness value exceeding the predefined first threshold is less than or equal to a predefined second threshold value. The display device 100 may perform the image processing on the plurality of image frames by using the image processing methods related to the display area adjustment, the frame rate adjustment and the blur correction when the total motion sickness value exceeds the predefined second threshold value.

According to another embodiment, the display device 100 may variably adjust a size of the image process related to the display area adjustment, the frame rate adjustment, and the blur correction depending on the size of the total motion sickness value. For example, when the size of the total motion sickness value exceeds the first threshold value, the display device 100 may adjust the display area to be reduced by 10%, the frame rate to be increased by 30%, and the blur to be intensified by 10%. When the total motion sickness value exceeds the second threshold value, the display device 100 may adjust the display area to be reduced by 30%, the frame rate to be increased by 50%, and the blur to be intensified by 30%.

Meanwhile, the image processing method of the display device 100 as described above may be implemented as at least one executable program, and the executable program may be stored in a non-transitory computer readable medium.

The non-transitory readable medium is not a medium for storing data for a short time such as a register, a cache, a memory, etc., but a medium that semi-permanently stores data and may be read by a device. To be specific, the above-mentioned programs may be stored in various computer-readable recording media such as a random access memory (RAM), a flash memory, a read only memory (ROM), an erasable programmable ROM (EPROM), an electronically erasable and programmable ROM (EEPROM) card, a register, a hard disk, a removable disk, a memory card, a USB memory, a USB memory, a compact disc-read only memory (CD-ROM), or the like.

The present disclosure has been described above with reference to preferred embodiments thereof.

Although the present disclosure has been described hereinabove with reference to exemplary embodiments and the drawings, the present disclosure is not limited thereto, but may be variously modified and altered by those skilled in the art to which the present disclosure pertains without departing from the spirit and scope of the present disclosure defined in the claims.

1. An image processing method of a display device comprising:
receiving a plurality of image frames configuring content;
determining a motion of a camera capturing the content by analyzing the plurality of image frames;
determining motion sickness on the basis of the camera motion captured; and
performing image processing on the plurality of image frames on the basis of the camera motion when the determined motion sickness has a value equal to or greater than a predetermined value.

2. The image processing method as claimed in claim 1, wherein the determining of the motion of a camera includes: detecting each feature point of the plurality of image frames; and
determining a size of each motion type of the camera based on an amount of changes in the detected feature points.

3. The image processing method as claimed in claim 2, wherein the motion type of the camera is at least one of a motion in an x-axis direction, a motion in a y-axis direction, a motion in a z-axis direction, a roll rotation motion in the x-axis direction, a pitch rotation motion in the y-axis direction, a yaw rotation motion in the z-axis direction and a jitter motion.

4. The image processing method as claimed in claim 2, wherein the determining of the motion sickness includes:
obtaining a motion sickness value based on a size of each motion type of the camera;
assigning a weight to the motion sickness value of the each motion type of the camera; and
calculating a total motion sickness value by summing the weighted motion sickness values with each other.

5. The image processing method as claimed in claim 4, wherein the determining of the motion sickness further includes correcting the total motion sickness value based on at least one of user information and environment information.

6. The image processing method as claimed in claim 1, wherein the determining of the motion of a camera includes determining a size of each motion type of the camera capturing the content based on information included in metadata when the information on the camera motion is included in the metadata of the plurality of image frames.

7. The image processing method as claimed in claim 1, wherein the performing of the image processing includes performing the image processing on the plurality of image frames using at least one of a display area adjustment, a frame rate adjustment and a blur correction.

8. The image processing method as claimed in claim 7, wherein the performing of the image processing further includes performing the image processing on the plurality of image frames using at least one of camera shake correction, brightness and contrast correction, and depth correction.

9. The image processing method as claimed in claim 1, wherein the determining of the motion of a camera includes determining the camera motion when an operation mode for motion sickness reduction is a manual mode and a user command is input for executing the motion sickness reduction mode.

10. The image processing method as claimed in claim 1, wherein the content is a panoramic image generated by synthesizing images captured by a plurality of cameras.

11. A display device comprising:
a communicator configured to receive a plurality of image frames configuring content;
an image processor configured to perform image processing on the plurality of image frames; and
a processor configured to determine a motion of a camera capturing the content by analyzing the plurality of image frames, determine motion sickness on the basis of the determined motion, and control the image processor to perform the image processing on the plurality of image frames on the basis of the camera motion when the determined motion sickness has a value equal to or greater than a predefined value.

12. The display device as claimed in claim 11, wherein the processor detects each feature point of the plurality of image frames and determines a size of each motion type of the camera based on an amount of changes in the detected feature points.

13. The display device as claimed in claim 12, wherein the motion type of the camera is at least one of a motion in an x-axis direction, a motion in a y-axis direction, a motion in a z-axis direction, a roll rotation motion in the x-axis direction, a pitch rotation motion in the y-axis direction, a yaw rotation motion in the z-axis direction and a jitter motion.

14. The display device as claimed in claim 12, wherein the processor obtains a motion sickness value based on a size of each motion type of the camera;
assigns a weight to the motion sickness value of the each motion type of the camera; and
calculates a total motion sickness value by summing the weighted motion sickness values with each other.

15. The display device as claimed in claim 14, wherein the processor corrects the total motion sickness value based on at least one of user information and environment information.
